(19) United States
(12) Patent Application Publication
(10) Pub. No.: US 2020/0221679 A1
(43) Pub. Date: Jul. 16, 2020

(54) Fishing Gear Transport Assembly

(71) Applicant: Frank Werlein, Elk Mound, WI (US)

(72) Inventor: Frank Werlein, Elk Mound, WI (US)

(21) Appl. No.: 16/249,679

(22) Filed: Jan. 16, 2019

(51) Int. Cl. A01K 97/08; A01K 97/04; A01K 97/06

(52) U.S. Cl. CPC A01K 97/08; A01K 97/06; A01K 97/04

(57) ABSTRACT

A fishing gear transport assembly for ice fishing equipment includes an upper band, a lower band, a plurality of slats, a pair of couplers, a plurality of pairs of strap clips, and a plurality of retainers. Each coupler is coupled to the upper band and is configured to couple to a bucket to couple the upper band to the bucket. Each pair of strap clips is coupled a rear face of a respective slat so that the strap clips are positioned to couple singly and removably to the upper band and the lower band to couple the respective slat to the upper band and the lower band. Each retainer is coupled to a front face of a respective slat. The retainer is configured to hold a respective item so that the respective item is coupled to and transportable with the bucket.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art including information disclosed under 37 CFR 1.97 and 1.98.

The disclosure and prior art relates to transport assemblies and more particularly pertains to a new transport assembly for ice fishing equipment.

### BRIEF SUMMARY OF THE INVENTION

An embodiment of the disclosure meets the needs presented above by generally comprising an upper band, a lower band, a pair of couplers, a plurality of slats, a plurality of pairs of strap clips, and a plurality of retainers. Each coupler is coupled to the upper band and is configured to couple to a bucket to couple the upper band to the bucket. Each pair of strap clips is coupled a rear face of a respective slat so that the strap clips are positioned to couple singly and removably to the upper band and the lower band to couple the respective slat to the upper band and the lower band. Each retainer is coupled to a front face of a respective slat. The retainer is configured to hold a respective item so that the respective item is coupled to and transportable with the bucket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a fishing gear transport assembly according to an embodiment of the disclosure.

FIG. 2 is a side view of an embodiment of the disclosure.

FIG. 3 is a top view of an embodiment of the disclosure.

FIG. 4 is a perspective in-use view of an embodiment of the disclosure.

FIG. 5 is a partial cut-away perspective view of an embodiment of the disclosure.

### DETAILED DESCRIPTION OF THE INVENTION

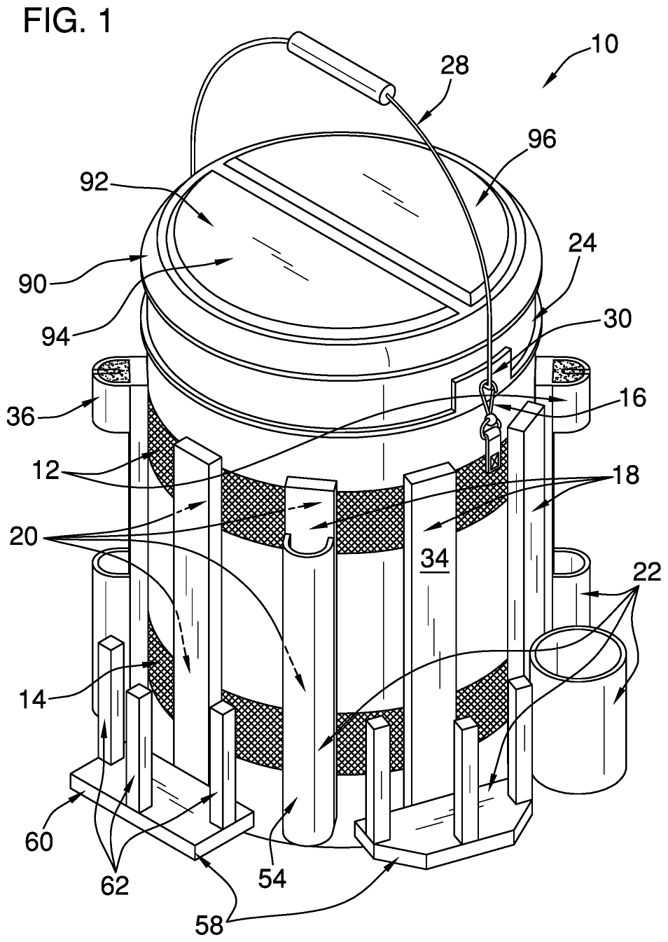

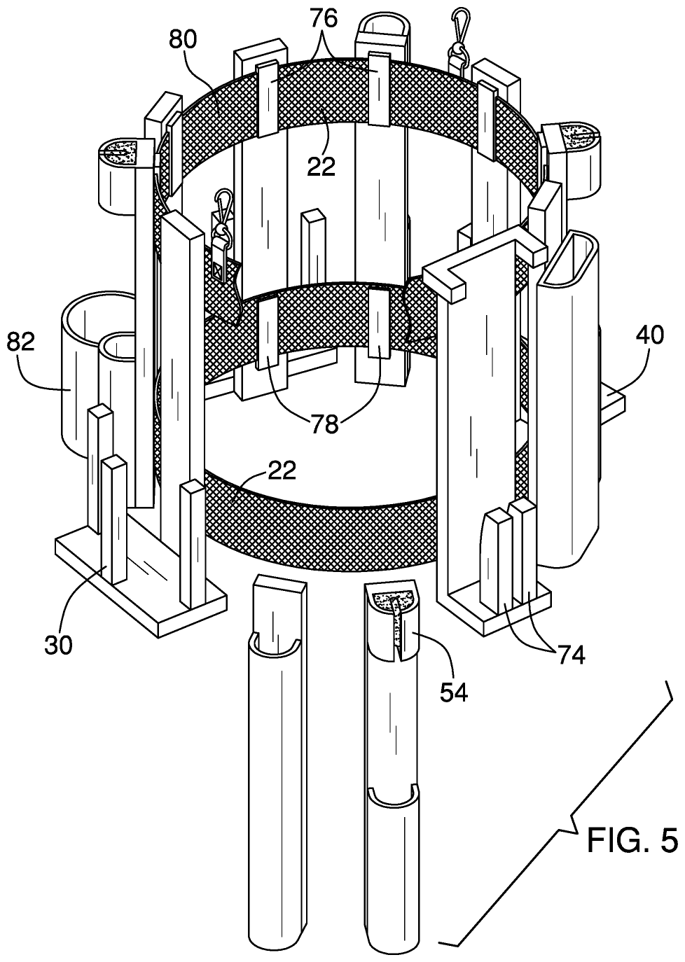

With reference now to the drawings, and in particular to FIGS. 1 through 5 thereof, a new transport assembly embodying the principles and concepts of an embodiment of the disclosure and generally designated by the reference numeral 10 will be described.

As best illustrated in FIGS. 1 through 5, the fishing gear transport assembly 10 generally comprises an upper band 12, a lower band 14, a pair of couplers 16, a plurality of slats 18, a plurality of pairs of strap clips 20, and a plurality of retainers 22. The upper band 12 and the lower band 14 comprise elastomer so that the upper band 12 and the lower band 14 are resiliently stretchable. The upper band 12 and the lower band 14 are configured to be stretched to insert a bucket 24 and to rebound to couple to the bucket 24.

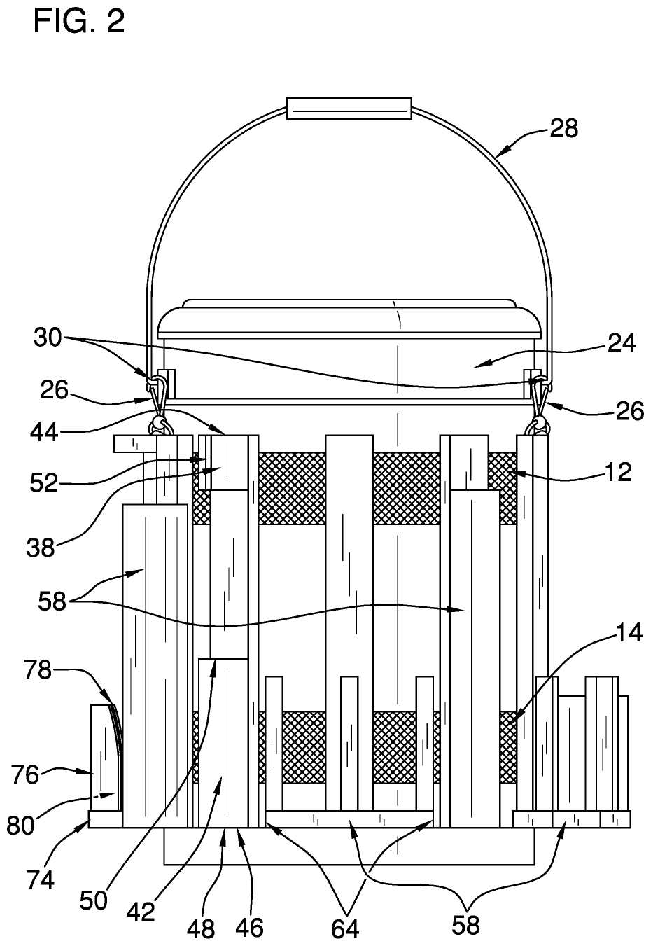

Each coupler 16 is coupled to the upper band 12 and is configured to couple to the bucket 24 to couple the upper band 12 to the bucket 24. Each coupler 16 comprises a lanyard clip 26 that is pivotally coupled to the upper band 12, as shown in FIG. 2. Each lanyard clip 26 is configured to couple to a handle 28 of the bucket 24 proximate to a respective opposing end 30 of the handle 28.

Each pair of strap clips 20 is coupled a rear face 32 of a respective slat 18 so that the strap clips 20 are positioned to couple singly and removably to the upper band 12 and the lower band 14 to couple the respective slat 18 to the upper band 12 and the lower band 14. As will become apparent, the slats 18 being removably couplable to the upper band 12 and the lower band 14 allows a user to configure the assembly 10 to suit the user's specific requirements.

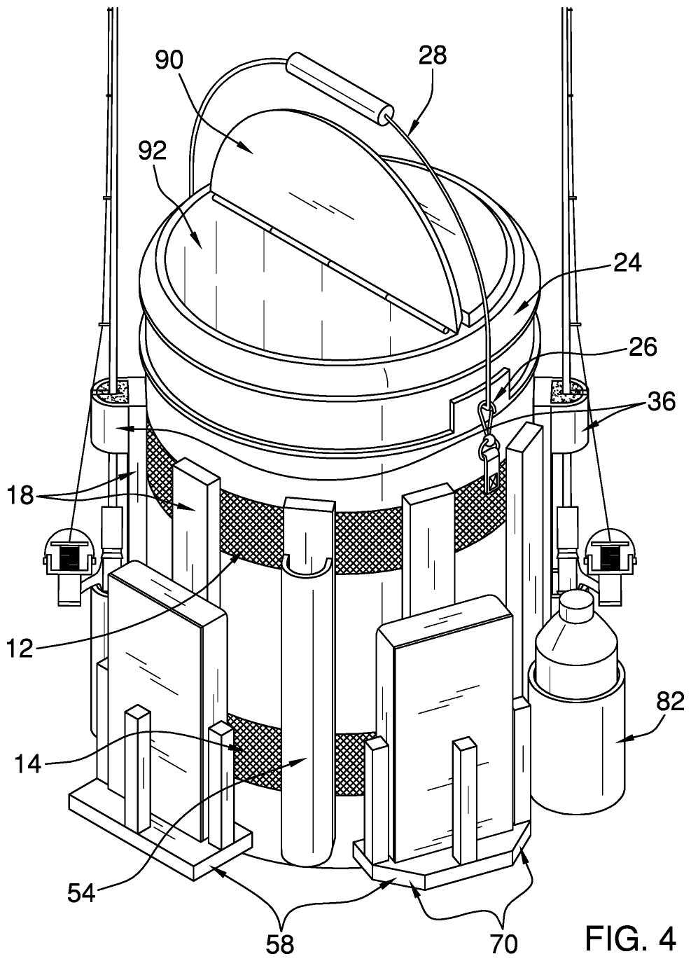

Each retainer 22 is coupled to a front face 34 of a respective slat 18. The retainer 22 is configured to hold a respective item, such as the items required for ice fishing, so that the respective item is coupled to and transportable with the bucket 24, as shown in FIG. 4.

The plurality of retainers 22 comprises a plurality of fishing rod holders 36. Each fishing rod holder 36 is configured to couple to a respective fishing rod so that the respective fishing rod is coupled to and transportable with the bucket 24.

Each fishing rod holder 36 comprises a rod tube 38, an insert 40, and a handle tube 42. The rod tube 38 is coupled to the respective slat 18 proximate to an upper end 44 of the respective slat 18. The insert 40, which comprises sponge or the like, is positioned in and is coupled to the rod tube 38. The handle tube 42 is coupled to the respective slat 18 proximate to a lower end 46 of the respective slat 18. The handle tube 42 has a bottom 48 and a top 50. The bottom 48 is closed, and the top 50 is open so that the handle tube 42 is configured to insert a handle of a fishing rod, positioning a pole of the fishing rod to be inserted into a slit 52 that extends into the rod tube 38 and the insert 40 so that the pole is frictionally coupled to the insert 40, as shown in FIG. 4.

The bottom 48 of the rod tube 38 is circumferentially smaller than the top 50 of the rod tube 38 so that the rod tube 38 is tapered and configured to frictionally couple to the handle of the fishing rod. The plurality of fishing rod holders 36 comprises three fishing rod holders 36.

The plurality of retainers 22 also comprises a plurality of pole holders 54. Each pole holder 54 is configured to couple to a pole of a respective tool, such as a fish net, so that the respective tool is coupled to and transportable with the bucket 24.

Each pole holder 54 comprises a pole tube 56 that is coupled to the respective slat 18. The pole tube 56 extends from proximate to the upper end 44 of the respective slat 18 to proximate to the lower end 46 of the respective slat 18. The pole tube 56 is open-topped and closed-bottomed so that the pole tube 56 is configured to insert the pole of the respective tool. The plurality of pole holders 54 comprises two pole holders 54.

The plurality of retainers 22 also comprises a plurality of container holders 58. Each container holder 58 is configured to couple to a respective container, such as a tackle box, so that the respective container is coupled to and transportable with the bucket 24, as shown in FIG. 4.

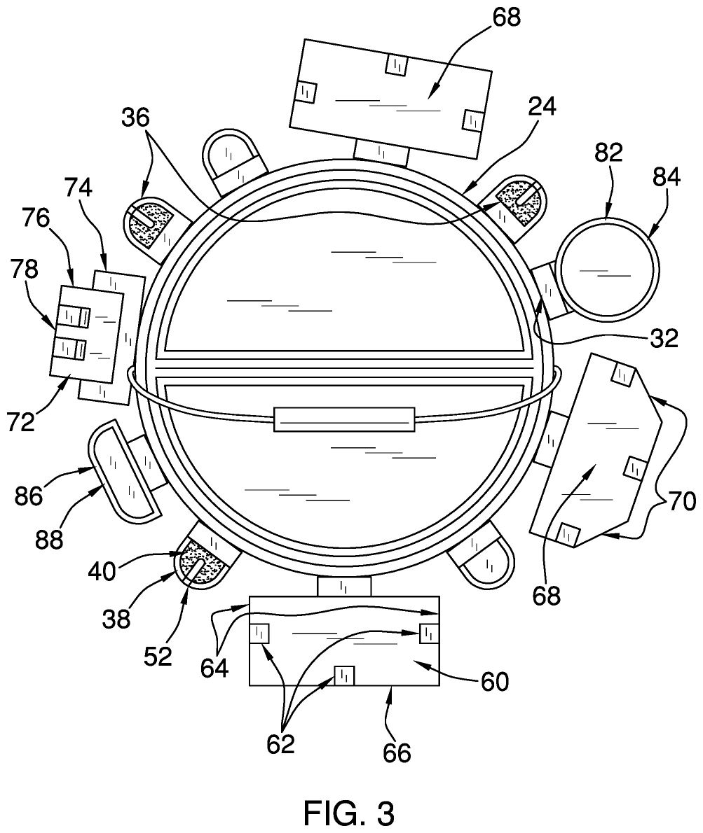

Each container holder 58 comprises a base plate 60 and a set of three bars 62. The base plate 60 is coupled to and extends perpendicularly from the lower end 46 of the respective slat 18. The bars 62 are coupled singly to and extend perpendicularly from opposing endpoints 64 and a respective opposing side 66 of the base plate 60 toward the upper end 44 of the respective slat 18 so that the respective slat 18 and the set of three bars 62 to define a rectangular space 68. The rectangular space 68 is configured to insert a substantially complementarily shaped container, such as the tackle box. The plurality of container holders 58 comprises three container holders 58. A pair of cutouts 70 extends into a respective base plate 60, as shown in FIG. 3, so that the respective base plate 60 is half-octagonally shaped.

The plurality of retainers 22 also comprises a plurality of tie-up holders 72. Each tie-up holder 72 is configured to couple to a respective tie-up so that the respective tie-up is coupled to and transportable with the bucket 24.

Each tie-up holder 72 comprises a first plate 74, a second plate 76, and a slot 78. The first plate 74 is coupled to and extends perpendicularly from the lower end 46 of the respective slat 18. The second plate 76 is coupled to and extends perpendicularly from the first plate 74 distal from the respective slat 18 to define a recess 80. The slot 78 extends into the second plate 76. The recess 80 is configured to insert an end of the respective tie-up concurrently with a tubular element of the respective tie-up being inserted into the slot 78. The plurality of tie-up holders 72 comprises one tie-up holder 72.

The plurality of retainers 22 also comprises a plurality of bottle holders 82. Each bottle holder 82 is configured to couple to a respective bottle so that the respective bottle is coupled to and transportable with the bucket 24.

Each bottle holder 82 comprises a bottle tube 84 that is coupled to the respective slat 18 proximate to the lower end 46 of the respective slat 18. The bottle tube 84 is open-topped and closed-bottomed so that the bottle tube 84 is configured to insert the respective bottle. The plurality of bottle holders 82 comprises one bottle holder 82.

The plurality of retainers 22 also comprises a plurality of multi-purpose holders 86. Each multi-purpose holder 86 is configured to couple to a respective article so that the respective article is coupled to and transportable with the bucket 24. Each multi-purpose holder 86 comprises a dish 88 that is coupled to the respective slat 18 proximate to the lower end 46 of the respective slat 18. The dish 88 is substantially D-shaped when viewed from the upper end 44 of the respective slat 18. The plurality of multi-purpose holders 86 comprises one multi-purpose holder 86.

A lid 90 is selectively couplable to an opening 92 of the bucket 24 to close the opening 92. The lid 90 comprises a first section 94 that is pivotally coupled to a second section 96. The first section 94 and the second section 96 are semi-circularly shaped.

In use, the bucket 24 is positioned in the upper band 12 and the lower band 14, and then the upper band 12 is coupled to the handle 28 of the bucket 24 using the lanyard clips 26. The ice fishing gear required by the user is positioned in the retainers 22, allowing the user to lift and transport both the bucket 24 and the gear.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing gear transport assembly comprising:
an upper band and a lower band;
a pair of couplers coupled to the upper band, each coupler being configured for coupling to a bucket wherein the pair of couplers is configured for coupling the upper band to the bucket;
a plurality of slats;
a plurality of pairs of strap clips, each pair of strap clips being coupled a rear face of a respective slat such that the strap clips are positioned for coupling singly and removably to the upper band and the lower band for coupling the respective slat to the upper band and the lower band; and
a plurality of retainers, each retainer being coupled to a front face of a respective slat wherein the retainer is configured for holding a respective item such that the respective item is coupled to and transportable with the bucket.

2. The assembly of claim 1, further including the upper band and the lower band comprising elastomer such that the upper band and the lower band are resiliently stretchable wherein the upper band and the lower band are configured for stretching for inserting the bucket and for rebounding for coupling to the bucket.

3. The assembly of claim 1, further including each coupler comprising a lanyard clip pivotally coupled to the upper band wherein each lanyard clip is configured for coupling to a handle of the bucket proximate to a respective opposing end of the handle.

4. The assembly of claim 1, further including the plurality of retainers comprising:
a plurality of fishing rod holders wherein each fishing rod holder is configured for coupling to a respective fishing rod such that the respective fishing rod is coupled to and transportable with the bucket;
a plurality of pole holders wherein each pole holder is configured for coupling to a pole of a respective tool such that the respective tool is coupled to and transportable with the bucket;
a plurality of container holders wherein each container holder is configured for coupling to a respective container such that the respective container is coupled to and transportable with the bucket;
a plurality of tie-up holders wherein each tie-up holder is configured for coupling to a respective tie-up such that the respective tie-up is coupled to and transportable with the bucket;
a plurality of bottle holders wherein each bottle holder is configured for coupling to a respective bottle such that the respective bottle is coupled to and transportable with the bucket; and
a plurality of multi-purpose holders wherein each multi-purpose holder is configured for coupling to a respective article such that the respective article is coupled to and transportable with the bucket.

5. The assembly of claim 4, further comprising:
the plurality of fishing rod holders comprising three fishing rod holders;
the plurality of pole holders comprising two pole holders;
the plurality of container holders comprising three container holders;
the plurality of tie-up holders comprising one tie-up holder;
the plurality of bottle holders comprising one bottle holder; and
the plurality of multi-purpose holders comprising one multi-purpose holder.

6. The assembly of claim 4, further including each fishing rod holder comprising a rod tube, an insert, and a handle tube, the rod tube being coupled to the respective slat proximate to an upper end of the respective slat, the insert being positioned in and coupled to the rod tube, the handle tube being coupled to the respective slat proximate to a lower end of the respective slat, the handle tube having a bottom and a top, the bottom being closed, the top being open wherein the handle tube is configured for inserting a handle of a fishing rod positioning a pole of the fishing rod for inserting into a slit extending into the rod tube and the insert such that the pole is frictionally coupled to the insert.

7. The assembly of claim 6, further including the bottom of the rod tube being circumferentially smaller than the top of the rod tube such that the rod tube is tapered wherein the rod tube is configured for frictionally coupling to the handle of the fishing rod.

8. The assembly of claim 4, further including each pole holder comprising a pole tube coupled to the respective slat, the pole tube extending from proximate to an upper end of the respective slat to proximate to a lower end of the respective slat, the pole tube being open-topped and closed-bottomed wherein the pole tube is configured for inserting the pole of the respective tool.

9. The assembly of claim 4, further including each container holder comprising a base plate and a set of three bars, the base plate being coupled to and extending perpendicularly from a lower end of the respective slat, the bars being coupled singly to and extending perpendicularly from opposing endpoints and a respective opposing side of the base plate toward the upper end of the respective slat such that the respective slat and the set of three bars define a rectangular space wherein the rectangular space is configured for inserting a substantially complementarily shaped container.

10. The assembly of claim 9, further including a pair of cutouts extending into a respective plate such that the respective plate is half-octagonally shaped.

11. The assembly of claim 4, further including each tie-up holder comprising a first plate, a second plate, and a slot, the first plate being coupled to and extending perpendicularly from a lower end of the respective slat, the second plate being coupled to and extending perpendicularly from the first plate distal from the respective slat defining a recess, the slot extending into the second plate wherein the recess is configured for inserting an end of the respective tie-up concurrently with a tubular element of the respective tie-up being inserted into the slot.

12. The assembly of claim 4, further including each bottle holder comprising a bottle tube coupled to the respective slat proximate to a lower end of the respective slat, the bottle tube being open-topped and closed-bottomed wherein the bottle tube is configured for inserting the respective bottle.

13. The assembly of claim 4, further including each multi-purpose holder comprising a dish coupled to the respective slat proximate to a lower end of the respective slat, the dish being substantially D-shaped when viewed from an upper end of the respective slat.

14. A fishing gear transport assembly and bucket combination comprising:
a bucket;
a handle pivotally coupled to a rim of the bucket;
an upper band and a lower band positioned around the bucket;
a pair of couplers, each coupler being coupled to and extending between the upper band and the handle such that the upper band is coupled to the bucket;
a plurality of slats;
a plurality of pairs of strap clips, each pair of strap clips being coupled a rear face of a respective slat such that the strap clips are positioned for coupling singly and removably to the upper band and the lower band for coupling the respective slat to the upper band and the lower band; and
a plurality of retainers, each retainer being coupled to a front face of a respective slat wherein the retainer is configured for holding a respective item such that the respective item is coupled to and transportable with the bucket.

15. The assembly of claim 14, further including a lid selectively couplable to an opening of the bucket for closing the opening.

16. The assembly of claim 15, further including further including the lid comprising a first section pivotally coupled to a second section, the first section and the second section being semi-circularly shaped.

17. A fishing gear transport assembly comprising:
an upper band and a lower band, the upper band and the lower band comprising elastomer such that the upper band and the lower band are resiliently stretchable wherein the upper band and the lower band are configured for stretching for inserting a bucket and for rebounding for coupling to the bucket;
a pair of couplers coupled to the upper band, each coupler being configured for coupling to the bucket wherein the pair of couplers is configured for coupling the upper band to the bucket, each coupler comprising a lanyard clip pivotally coupled to the upper band wherein each lanyard clip is configured for coupling to a handle of the bucket proximate to a respective opposing end of the handle;
a plurality of slats;
a plurality of pairs of strap clips, each pair of strap clips being coupled a rear face of a respective slat such that the strap clips are positioned for coupling singly and removably to the upper band and the lower band for coupling the respective slat to the upper band and the lower band; and
a plurality of retainers, each retainer being coupled to a front face of a respective slat wherein the retainer is configured for holding a respective item such that the respective item is coupled to and transportable with the bucket, the plurality of retainers comprising:
a plurality of fishing rod holders wherein each fishing rod holder is configured for coupling to a respective fishing rod such that the respective fishing rod is coupled to and transportable with the bucket, each fishing rod holder comprising a rod tube, an insert, and a handle tube, the rod tube being coupled to the respective slat proximate to an upper end of the respective slat, the insert being positioned in and coupled to the rod tube, the handle tube being coupled to the respective slat proximate to a lower end of the respective slat, the handle tube having a bottom and a top, the bottom being closed, the top being open wherein the handle tube is configured for inserting a handle of a fishing rod positioning a pole of the fishing rod for inserting into a slit extending into the rod tube and the insert such that the pole is frictionally coupled to the insert, the bottom of the rod tube being circumferentially smaller than the top of the rod tube such that the rod tube is tapered wherein the rod tube is configured for frictionally coupling to the handle of the fishing rod, the plurality of fishing rod holders comprising three fishing rod holders,
a plurality of pole holders wherein each pole holder is configured for coupling to a pole of a respective tool such that the respective tool is coupled to and transportable with the bucket, each pole holder comprising a pole tube coupled to the respective slat, the pole tube extending from proximate to the upper end of the respective slat to proximate to the lower end of the respective slat, the pole tube being open-topped and closed-bottomed wherein the pole tube is configured for inserting the pole of the respective tool, the plurality of pole holders comprising two pole holders,
a plurality of container holders wherein each container holder is configured for coupling to a respective container such that the respective container is coupled to and transportable with the bucket, each container holder comprising a base plate and a set of three bars, the base plate being coupled to and extending perpendicularly from the lower end of the respective slat, the bars being coupled singly to and extending perpendicularly from opposing endpoints and a respective opposing side of the base plate toward the upper end of the respective slat such that the respective slat and the set of three bars define a rectangular space wherein the rectangular space is configured for inserting a substantially complementarily shaped container, the plurality of container holders comprising three container holders,
a pair of cutouts extending into a respective plate such that the respective plate is half-octagonally shaped,
a plurality of tie-up holders wherein each tie-up holder is configured for coupling to a respective tie-up such that the respective tie-up is coupled to and transportable with the bucket, each tie-up holder comprising a first plate, a second plate, and a slot, the first plate being coupled to and extending perpendicularly from the lower end of the respective slat, the second plate being coupled to and extending perpendicularly from the first plate distal from the respective slat defining a recess, the slot extending into the second plate wherein the recess is configured for inserting an end of the respective tie-up concurrently with a tubular element of the respective tie-up being inserted into the slot, the plurality of tie-up holders comprising one tie-up holder,
a plurality of bottle holders wherein each bottle holder is configured for coupling to a respective bottle such that the respective bottle is coupled to and transportable with the bucket, each bottle holder comprising a bottle tube coupled to the respective slat proximate to the lower end of the respective slat, the bottle tube being open-topped and closed-bottomed wherein the bottle tube is configured for inserting the respective bottle, the plurality of bottle holders comprising one bottle holder, and
a plurality of multi-purpose holders wherein each multi-purpose holder is configured for coupling to a respective article such that the respective article is coupled to and transportable with the bucket, each multi-purpose holder comprising a dish coupled to the respective slat proximate to the lower end of the respective slat, the dish being substantially D-shaped when viewed from the upper end of the respective slat, the plurality of multi-purpose holders comprising one multi-purpose holder.
